(19) United States
(12) Patent Application Publication
(10) Pub. No.: US 2013/0089755 A1
(43) Pub. Date: Apr. 11, 2013

(54) Battery Pack

(71) Applicants: In-Soo Park, Yongin-si (KR); Sang-Jin Park, Yongin-si (KR)

(72) Inventors: In-Soo Park, Yongin-si (KR); Sang-Jin Park, Yongin-si (KR)

(21) Appl. No.: 13/475,907

(22) Filed: May 18, 2012

Related U.S. Application Data
(60) Provisional application No. 61/545,836, filed on Oct. 11, 2011.

(51) Int. Cl. H01M 2/22; H01M 4/38; H01M 2/00

(52) U.S. Cl. 429/7; 429/211

(57) ABSTRACT

A battery pack and a lead electrode for a battery pack. A lead electrode includes a plurality of end connecting portions, each connectable to a battery cell or a protection circuit module, and a body portion connecting the plurality of end connecting portions and having a thickness greater than a thickness of the end connecting portions.

### CROSS-REFERENCE TO RELATED APPLICATION

This application claims priority to and the benefit of U.S. Provisional Application No. 61/545,836, filed on Oct. 11, 2011 in the United States Patent and Trademark Office, the entire content of which is incorporated herein by reference.

### BACKGROUND

1. Field

Aspects of embodiments of the present invention relate to a battery pack.

2. Description of the Related Art

Secondary batteries are chargeable/dischargeable batteries, unlike primary batteries that are unable to be charged. Such secondary batteries have been widely used in small high-tech electronic devices, such as mobile phones, personal digital assistants (PDAs), laptop computers, and the like, and in energy storing systems.

Secondary batteries may be a type of single battery or a plurality of batteries that are electrically connected to one another according to types of external electronic devices in which the secondary batteries are used. For example, small devices, such as mobile phones, are operable with output and capacity of one battery for a certain amount of time, whereas medium or large devices, such as laptop computers, portable digital versatile disc (DVD) players, small personal computers (PCs), and the like, use a plurality of batteries due to large output and capacity.

Battery packs including a protection circuit or the like connected to a plurality of battery cells connected in series and/or in parallel, are used. In order for such battery packs to have sufficient output and capacity when they are manufactured, electrical connection between the plurality of battery cells has to be stably performed. In addition, as the demand for smaller and thinner external electronic devices increases, there is a need for battery packs that are smaller and thinner.

### SUMMARY

According to an aspect of embodiments of the present invention, a battery pack includes a lead plate, or lead electrode, which may be used in a small space and easily and stably connected at connecting portions, and an overall size of the battery pack may thereby be reduced.

According to an embodiment of the present invention, a battery pack includes: a battery cell; a protection circuit module electrically connected to the battery cell; a case accommodating the battery cell; and a lead electrode electrically connected between the protection circuit module and the battery cell, the lead electrode including a plurality of end connecting portions, each connected to the battery cell or the protection circuit module, and a body portion connecting the plurality of end connecting portions and having a thickness greater than a thickness of the end connecting portions.

A width of an end connecting portion of the plurality of end connecting portions may be greater than a width of the body portion. In one embodiment, the end connecting portion of the plurality of end connecting portions is connected to the protection circuit module.

The body portion may include first and second overlapping metallic layers. In one embodiment, an end connecting portion of the plurality of end connecting portions includes a connecting portion of the first metallic layer that extends beyond and is not overlapped with the second metallic layer. In one embodiment, the first and second metallic layers are integrated together by at least one of welding or a conductive adhesive.

The battery cell may include an electrode tab at a first side thereof, and an end connecting portion of the plurality of end connecting portions may be connected to the electrode tab. In one embodiment, the battery cell further includes a terrace portion at the first side, and a width of the body portion is less than or equal to a width of the terrace portion.

An end connecting portion of the plurality of end connecting portions and the body portion may be bent with respect to each other.

A width of the body portion may be less than or equal to a thickness of the battery cell.

The lead electrode may further include an insulating material surrounding the body portion, and at least a portion of each of the end connecting portions may be exposed outside the insulating material.

The battery pack may further include an auxiliary lead tab electrically connected between an end connecting portion of the plurality of end connecting portions and the battery cell. In one embodiment, the auxiliary lead tab has a hole formed therein, and the case includes a protrusion engaged in the hole to fix a position of the auxiliary lead tab relative to the case. In one embodiment, the battery pack further includes a temperature cutoff (TCO) electrically connected between the end connecting portion of the plurality of end connecting portions and the auxiliary lead tab.

An end connecting portion of the plurality of end connecting portions may have a hole formed therein, and the case may include a protrusion engaged in the hole to fix a position of the end connecting portion of the plurality of end connecting portions relative to the case.

According to another embodiment of the present invention, a lead electrode for a battery pack includes: a plurality of end connecting portions; and a body portion connecting the plurality of end connecting portions and having a thickness greater than a thickness of the end connecting portions.

A width of an end connecting portion of the plurality of end connecting portions may be greater than a width of the body portion.

The body portion may include first and second overlapping metallic layers. In one embodiment, the first and second metallic layers are integrated together by at least one of welding or a conductive adhesive.

The lead electrode may further include an insulating material surrounding the body portion, at least a portion of each of the end connecting portions being exposed outside the insulating material.

### BRIEF DESCRIPTION OF THE DRAWINGS

The accompanying drawings, together with the specification, illustrate some exemplary embodiments of the present invention, and, together with the description, serve to explain aspects and principles of the present invention.

FIG. 1A is an exploded perspective view schematically illustrating a lead plate according to an embodiment of the present invention;

FIG. 1B is a perspective view of the lead plate of FIG. 1A;

FIG. 1C is a perspective view of the lead plate of FIG. 1A that is coated with an insulating material;

FIG. 2A is an exploded perspective view schematically illustrating a lead plate according to another embodiment of the present invention;

FIG. 2B is a perspective view of the lead plate of FIG. 2A;

FIG. 2C is a perspective view of the lead plate of FIG. 2A that is coated with an insulating material;

FIG. 3A is an exploded perspective view schematically illustrating a lead plate according to another embodiment of the present invention;

FIG. 3B is a perspective view of the lead plate of FIG. 3A;

FIG. 3C is a perspective view of the lead plate of FIG. 3A that is coated with an insulating material;

FIG. 4 is an exploded perspective view schematically illustrating a battery pack according to an embodiment of the present invention;

FIG. 5A is a perspective view of a lead plate, a temperature cutoff (TCO), and auxiliary lead tabs of the battery pack of FIG. 4;

FIG. 5B is an exploded perspective view of the lead plate, the temperature cutoff (TCO), and the auxiliary lead tabs of FIG. 5A;

FIG. 6 is a perspective view of another lead plate of the battery pack of FIG. 4;

FIG. 7 is a partially exploded perspective view of a portion of the battery pack of FIG. 4;

FIG. 8 is an exploded perspective view schematically illustrating a battery pack according to another embodiment of the present invention;

FIG. 9 is a perspective view of a lead plate of the battery pack of FIG. 8; and

FIG. 10 is a perspective view of another lead plate of the battery pack of FIG. 8.

### DESCRIPTION OF REFERENCE NUMERALS INDICATING SOME ELEMENTS IN THE DRAWINGS

| | |
|---|---|
| 10, 20, 30: lead plate | 11, 21, 31: first metallic layer |
| 12, 22, 32: second metallic layer | 10a, 20a, 30a: body portion |
| 10b, 20b, 30b: electrode connecting | |
| portion | |
| 10c, 20c, 30c: terminal connecting | |
| portion | |
| S: insulating material | 400, 500: battery pack |
| 410, 510: battery cells | 420, 520: protection circuit module |
| 431, 531: lower case | 432, 532: upper case |
| 440, 540: first lead plate | 442: TCO |
| 444: auxiliary lead tabs | 450, 550: second lead plate |
| 460, 560: third lead plate | 570: fourth lead plate |
| 580: fifth lead plate | |

### DETAILED DESCRIPTION

The present invention will be described more fully hereinafter with reference to the accompanying drawings, in which some exemplary embodiments of the invention are shown and described. However, as those skilled in the art would realize, the described embodiments may be modified in various different ways, all without departing from the spirit or scope of the present invention. Accordingly, the drawings and description are to be regarded as illustrative in nature and not restrictive. The terminology used herein is for the purpose of describing particular embodiments and is not intended to be limiting of other embodiments. Like reference numerals designate like elements throughout the specification. As used herein, the singular forms “a,” “an,” and “the” are intended to include the plural forms as well, unless the context clearly indicates otherwise. It will be further understood that the terms “comprises” and/or “comprising” as used herein specify the presence of stated features, integers, steps, operations, members, components, and/or groups thereof, but do not preclude the presence or addition of one or more other features, integers, steps, operations, members, components, and/or groups thereof. It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. It will be understood that when an element, such as a layer, a region, or a substrate, is referred to as being “on,” “connected to,” or “coupled to” another element, it may be directly on, connected or coupled to the other element or one or more intervening elements may be present.

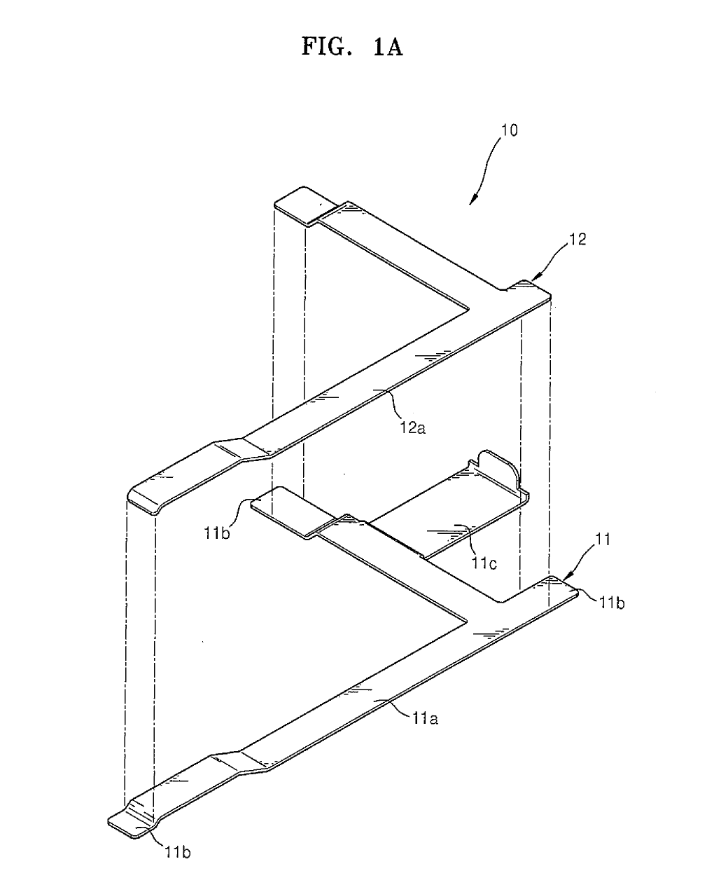

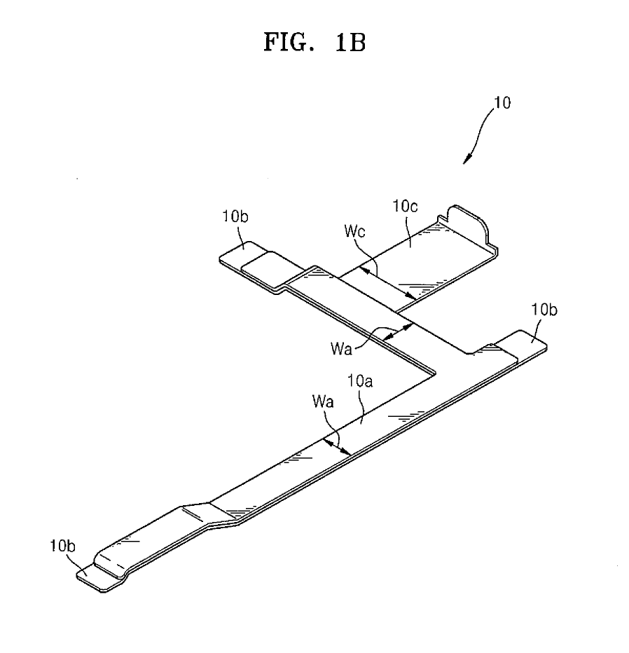

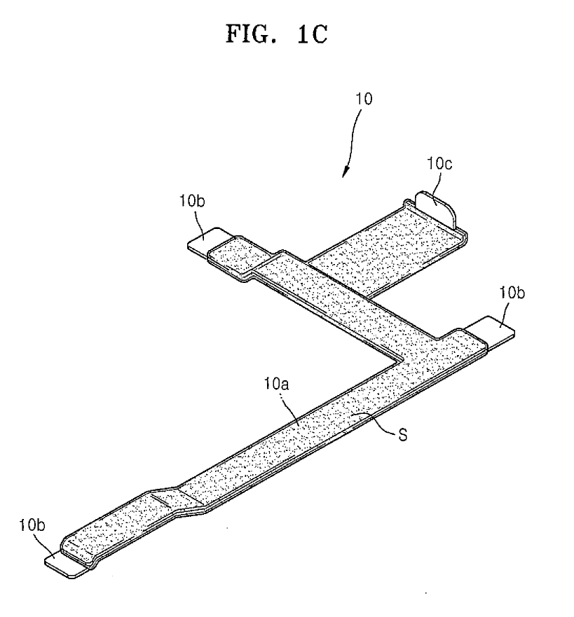

FIG. 1A is an exploded perspective view schematically illustrating a lead plate 10 according to an embodiment of the present invention; FIG. 1B is a perspective view of the lead plate 10 illustrated in FIG. 1A; and FIG. 1C is a perspective view of the lead plate 10 illustrated in FIG. 1A that is coated with an insulating material.

The lead plate 10, or lead electrode, is a medium that electrically connects elements of a battery pack. The lead plate 10 may electrically connect a plurality of battery cells or a battery cell and a protection circuit module. Alternatively, the plurality of battery cells and the protection circuit module may be concurrently (e.g., simultaneously) electrically connected to one another by the lead plate 10, as described below.

Referring to FIG. 1A, the lead plate 10 may include at least two metallic layers. In one embodiment, the lead plate 10 includes a first metallic layer 11 and a second metallic layer 12. The first and second metallic layers 11 and 12 are formed of a conductive material such that a current flows through the first and second metallic layers 11 and 12. The conductive material, in one embodiment, may be nickel (Ni), iron (Fe), aluminum (Al), copper (Cu), or an alloy thereof. The first metallic layer 11 and the second metallic layer 12 may be integrated with each other by welding, such as spot welding, ultrasonic welding, laser welding, soldering, or the like. In one embodiment, the first and second metallic layers 11 and 12 may include the same material so as to improve an adhesion property thereof (e.g., by welding). In another embodiment, the first metallic layer 11 and the second metallic layer 12 may be integrated with each other by using a conductive adhesive.

The first metallic layer 11 may include a first body portion 11a and a terminal connecting portion 11c that extends in a direction from the first body portion 11a. The first body portion 11a may be approximately T-shaped, and a width of the first body portion 11a is smaller than a width of the terminal connecting portion 11c.

The second metallic layer 12 include a second body portion 12a that may be approximately T-shaped so as to overlap with the first body portion 11a. Ends of the second body portion 12a are shorter than corresponding ends of the first body portion 11a, and, thus, when the first and second metallic layers 11 and 12 overlap with each other, the ends of the first body portion 11a constitute electrode connecting portions 11b that do not overlap with the second metallic layer 12 and are exposed to the outside. The electrode connecting portions 11b may be electrically connected to electrodes of the battery cell by welding.

When the first and second metallic layers 11 and 12 overlap with each other, a portion of the first metallic layer 11 that does not overlap with the second metallic layer 12 may also be the terminal connecting portion 11c as well as the ends of the first body portion 11a. The terminal connecting portion 11c extends in a direction from the first body portion 11a and has a greater width than that of the first body portion 11a. The terminal connecting portion 11c may be electrically connected to terminals of the protection circuit module by welding.

Referring to FIG. 1B, the first and second metallic layers 11 and 12 overlap with each other and are integrated with each other such that the lead plate 10 is formed. The first body portion 11a and the second body portion 12a overlap with each other such that a body portion 10a of the lead plate 10 is formed, and ends of the first body portion 11a that do not overlap with the second body portion 12a, that is, the electrode connecting portions 11b and the terminal connecting portion 11c of the first body portion 11a, constitute electrode connecting portions 10b and a terminal connecting portion 10c of the lead plate 10, respectively. The body portion 10a of the lead plate 10 is formed as two metallic layers, whereas each of the electrode connecting portions 10b and the terminal connecting portion 10c of the lead plate 10 is formed as one metallic layer.

Each of the electrode connecting portions 10b and the terminal connecting portion 10c of the lead plate 10 is formed as one metallic layer, and, thus, the electrode connecting portions 10b and the terminal connecting portion 10c may be easily welded. If each of the electrode connecting portions 10b and the terminal connecting portion 10c is formed as two metallic layers, welding of the metallic layers that constitute the electrode connecting portions 10b or the terminal connecting portion 10c and welding of elements to be welded to the metallic layers, such as electrodes of the battery cell or terminals of the protection circuit module, have to be performed. Thus, the number of welding processes increases, and an adhesive force therebetween is lowered compared to an adhesive force of the electrode connecting portions 10b and the terminal connecting portion 10c, each of which is formed as one metallic layer.

The body portion 10a of the lead plate 10 is formed by overlapping two metallic layers with each other and, thus, has an increased thickness, and a width of the lead plate 10 may be reduced compared to a width of a lead plate formed as one metallic layer. That is, the body portion 10a of the lead plate 10 includes at least two metallic layers such that the width of the lead plate 10 may be reduced and to prevent or reduce an increase in resistance of the lead plate 10. On the other hand, since the terminal connecting portion 10c is formed as one metallic layer, resistance of the terminal connecting portion 10c may be increased compared to resistance of the body portion 10a of the lead plate 10. In order to prevent or reduce such an increase in resistance of the terminal connecting portion 10c, a width Wc of the terminal connecting portion 10c, in one embodiment, is greater than a width Wa of the body portion 10a.

Referring to FIG. 1C, the lead plate 10 excluding a portion for electrical connection may be surrounded by an insulating material “S,” thereby preventing or substantially preventing a short circuit between peripheral devices. For example, the insulating material “S” may surround the lead plate 10 excluding the electrode connecting portions 10b and the terminal connecting portion 10c of the lead plate 10. The insulating material “S” may include a suitable material, such as polyimide (PI). In one embodiment, a length of the terminal connecting portion 10c is long such that the insulating material “S” may surround the remaining regions of the terminal connecting portion 10c while an end of the terminal connecting portion 10c is exposed to the outside.

According to another embodiment of the present invention, the length of the terminal connecting portion 10c may be short, similar to the electrode connecting portions 10b. In this case, the terminal connecting portion 10c may not be surrounded by the insulating material “S” and may be exposed to the outside, as in the electrode connecting portions 10b, and the width Wc of the terminal connecting portion 10c may not be greater than the width Wa of the body portion 10a.

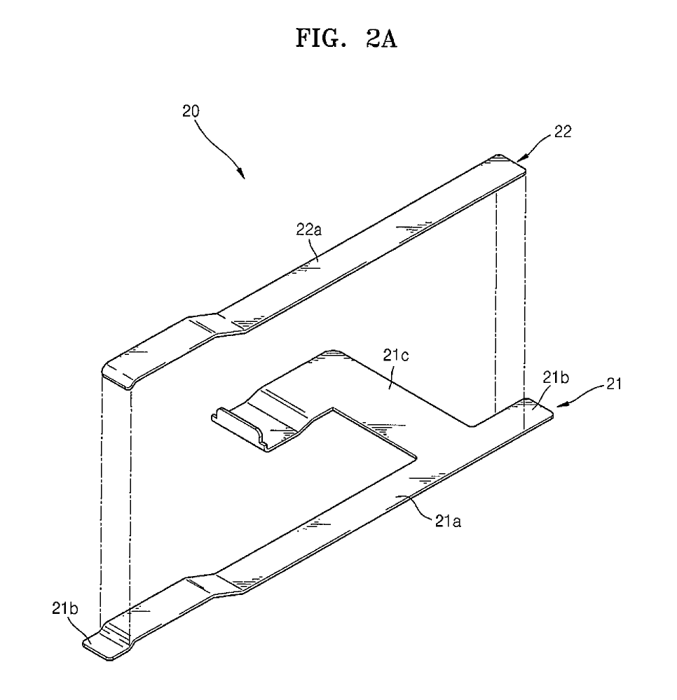

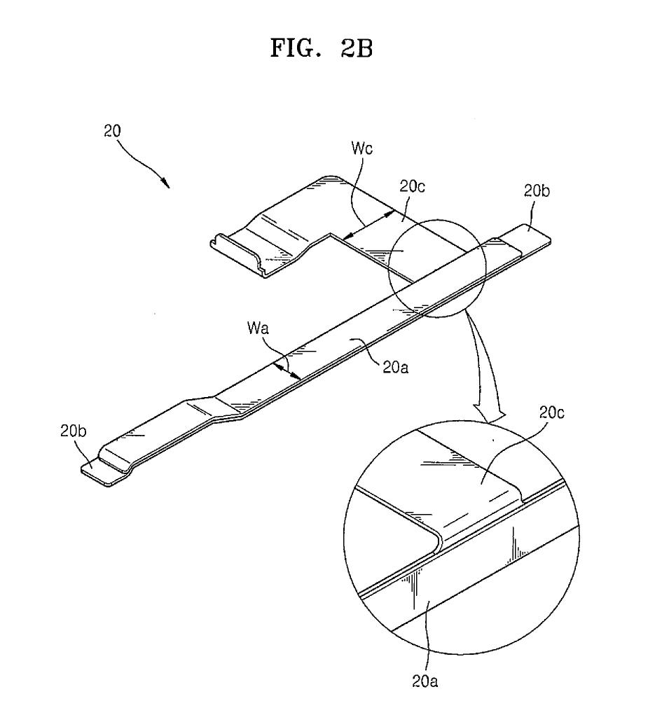

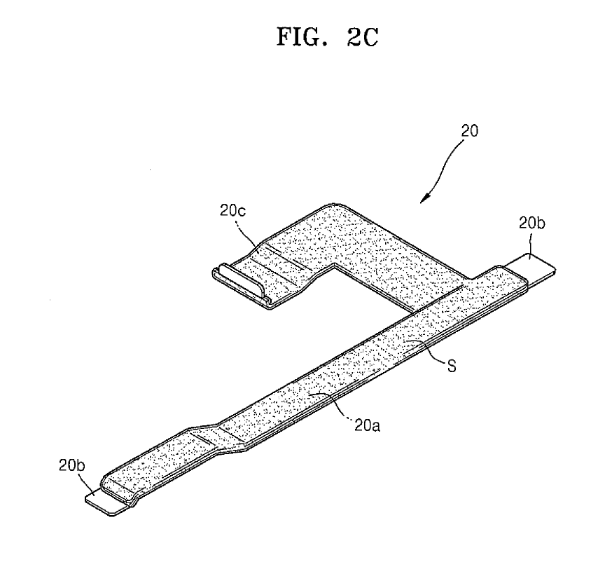

FIG. 2A is an exploded perspective view schematically illustrating a lead plate 20 according to another embodiment of the present invention; FIG. 2B is a perspective view of the lead plate 20 illustrated in FIG. 2A; and FIG. 2C is a perspective view of the lead plate 20 illustrated in FIG. 2A that is coated with an insulating material.

Referring to FIG. 2A, the lead plate 20, or lead electrode, may be formed by integrating a first metallic layer 21 and a second metallic layer 22 with each other, such as by welding or by using a conductive adhesive. In one embodiment, the first metallic layer 21 and the second metallic layer 22 may be formed of the same metallic material so as to improve an adhesion property thereof (e.g., by welding).

The first metallic layer 21 may include a first body portion 21a and a terminal connecting portion 21c that extends in a direction from the first body portion 21a. The first body portion 21a may be approximately I-shaped, and the terminal connecting portion 21c may be L-shaped.

The second metallic layer 22, in one embodiment, includes a second body portion 22a that may be approximately I-shaped so as to overlap with the first body portion 21a and is shorter than the first body portion 21a such that, when the first and second metallic layers 21 and 22 overlap with each other, ends of the first body portion 21a may constitute electrode connecting portions 21b that are not overlapped with the second metallic layer 22 and are exposed to the outside.

Referring to FIG. 2B, in one embodiment, the lead plate 20 is formed by overlapping the first and second metallic layers 21 and 22 with each other and includes a body portion 20a that is formed as two metallic layers, and electrode connecting portions 20b and a terminal connecting portion 20c, each of which is formed as one metallic layer. The electrode connecting portions 20b may extend from both ends of the body portion 20a and may be electrically connected to the electrodes of the battery cell, and the terminal connecting portion 20c may extend from a side of the body portion 20a and may be electrically connected to the terminals of the protection circuit module.

In one embodiment, the body portion 20a of the lead plate 20 is formed by overlapping two metallic layers with each other and thus has an increased thickness, and a width of the lead plate 20 may be reduced compared to a width of a lead plate formed as one metallic layer. On the other hand, since the terminal connecting portion 20c is formed as one metallic layer, resistance of the terminal connecting portion 20c may be increased compared to resistance of the body portion 20a of the lead plate 20.

In order to prevent or reduce such an increase in resistance of the terminal connecting portion 20c, a width Wc of the terminal connecting portion 20c, in one embodiment, is greater than a width Wa of the body portion 20a.

Referring to an enlarged portion of FIG. 2B, the terminal connecting portion 20c and the body portion 20a may be bent approximately perpendicular to each other. Accordingly, even though a plurality of battery cells and a protection circuit module may be arranged in various shapes, the lead plate 20 may be positioned in a proper position.

Referring to FIG. 2C, the lead plate 20 excluding a portion for electrical connection may be surrounded by an insulating material “S” and may prevent or substantially prevent a short circuit between peripheral devices. In one embodiment, the terminal connecting portion 20c extends to a length, and the remaining regions of the lead plate 20 excluding the end of the terminal connecting portion 20c may be surrounded by the insulating material “S.”

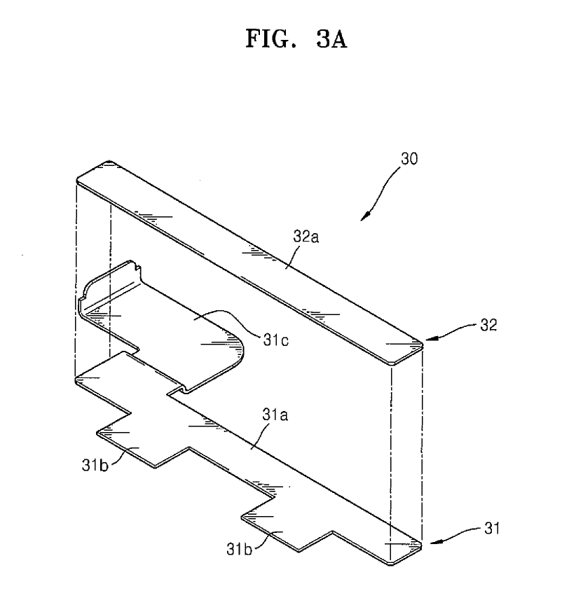

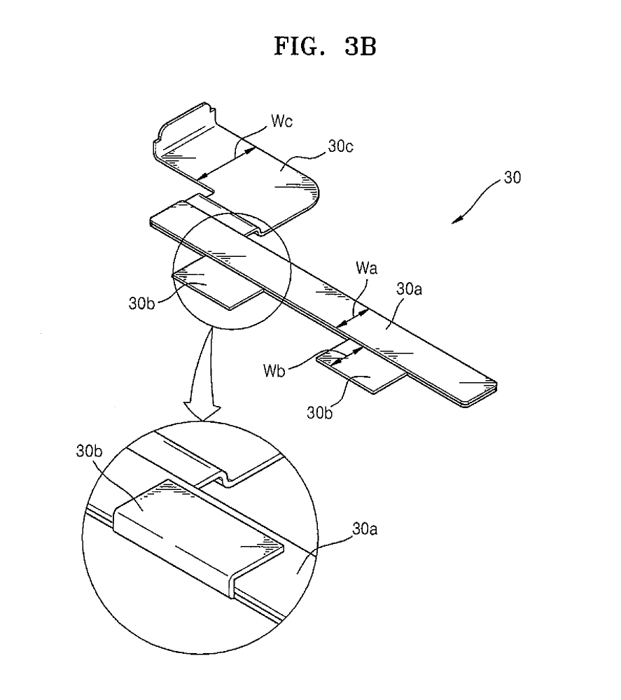

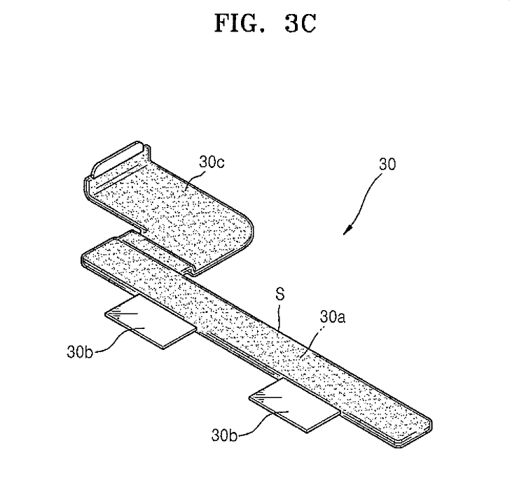

FIG. 3A is an exploded perspective view schematically illustrating a lead plate 30 according to another embodiment of the present invention; FIG. 3B is a perspective view of the lead plate 30 illustrated in FIG. 3A; and FIG. 3C is a perspective view of the lead plate 30 illustrated in FIG. 3A that is coated with an insulating material.

Referring to FIG. 3A, the lead plate 30, or lead electrode, may be formed by integrating a first metallic layer 31 and a second metallic layer 32 with each other, such as by welding or by using a conductive adhesive. In one embodiment, the first metallic layer 31 and the second metallic layer 32 may be formed of the same metallic material so as to improve an adhesion property thereof (e.g., by welding).

The first metallic layer 31 may include a first body portion 31a, electrode connecting portions 31b that extend in a direction from the first body portion 31a, and a terminal connecting portion 31c that extends from a side of the first body portion 31a. The first body portion 31a, in one embodiment, may be approximately I-shaped, and the terminal connecting portion 31c may be L-shaped. The second metallic layer 32 includes a second body portion 32a that may be approximately I-shaped so as to overlap with the first body portion 31a.

In one embodiment, the lead plate 30 is formed by overlapping the first and second metallic layers 31 and 32 with each other, and the terminal connecting portion 31c and the electrode connecting portions 31b of the first metallic layer 31 are not overlapped with the second metallic layer 32.

Referring to FIG. 3B, in one embodiment, the lead plate 30 is formed by overlapping the first and second metallic layers 31 and 32 with each other and includes a body portion 30a that is formed as two metallic layers, and electrode connecting portions 30b and a terminal connecting portion 30c, each of which is formed as one metallic layer. The electrode connecting portions 30b may protrude from a side of the body portion 30a and may be electrically connected to the electrodes of the battery cell. The terminal connecting portion 30c may extend from a side of the body portion 30a and may be electrically connected to the terminals of the protection circuit module.

In one embodiment, the body portion 30a of the lead plate 30 is formed by overlapping two metallic layers with each other and thus has an increased thickness, and a width of the lead plate 30 may be reduced compared to a width of a lead plate formed as one metallic layer. On the other hand, since the terminal connecting portion 30c is formed as one metallic layer, resistance of the terminal connecting portion 30c may be increased compared to resistance of the body portion 30a of the lead plate 30. In order to prevent or reduce such an increase in resistance of the terminal connecting portion 30c, a width Wc of the terminal connecting portion 30c, in one embodiment, is greater than a width Wa of the body portion 30a.

Referring to an enlarged portion of FIG. 3B, the electrode connecting portions 30b may be bent toward the body portion 30a of the lead plate 30. Accordingly, even though a plurality of battery cells and a protection circuit module may be arranged in various shapes, the lead plate 30 may be positioned in a proper position.

For example, in one embodiment, the electrode connecting portions 30b may be bent toward the body portion 30a so as to be approximately parallel to the body portion 30a of the lead plate 30. In one embodiment, a width Wb of the electrode connecting portion 30b may be the same as or less than the width Wa of the body portion 30a such that the bent electrode connecting portions 30b do not protrude in a widthwise direction of the body portion 30a.

Referring to FIG. 3C, the lead plate 30 excluding a portion for electrical connection may be surrounded by an insulating material “S” and may prevent or substantially prevent a short circuit between peripheral devices. In one embodiment, the terminal connecting portion 30c extends to a length, and the remaining regions of the lead plate 30 excluding the end of the terminal connecting portion 30c may be surrounded by the insulating material “S.”

The lead plates 10, 20, and 30 described above with respect to FIGS. 1A through 1C, FIGS. 2A through 2C, and FIGS. 3A through 3C, respectively, may include at least two metallic layers so as to increase thicknesses of the body portions 10a, 20a, and 30a and to reduce widths thereof. An increase in resistance of the terminal connecting portions 10c, 20c, and 30c may be prevented or substantially prevented while the widths of the body portions 10a, 20a, and 30a may be reduced, such that electrodes of the battery cell or the battery cell and the protection circuit module may be electrically connected to each other in a narrow space.

In addition, each of the electrode connecting portions 10b, 20b, and 30b and the terminal connecting portions 10c, 20c, and 30c to be welded is formed as a one metallic layer such that the electrode connecting portions 10b, 20b, and 30b may be easily electrically connected to the electrodes of the battery cell by welding, and the terminal connecting portions 10c, 20c, and 30c may be easily connected to the terminals of the protection circuit module by welding.

In one embodiment, the widths of the terminal connecting portions 10c, 20c, 30c, each of which is formed as one metallic layer, are greater than the widths of the body portions 10a, 20a, and 30a such that resistance may be prevented or substantially prevented from being increased when currents that have flowed through the body portions 10a, 20a, and 30a formed as two metallic layers flow through the terminal connecting portions 10c, 20c, and 30c.

A battery pack using lead plates, or lead electrodes, according to embodiments of the present invention is described below.

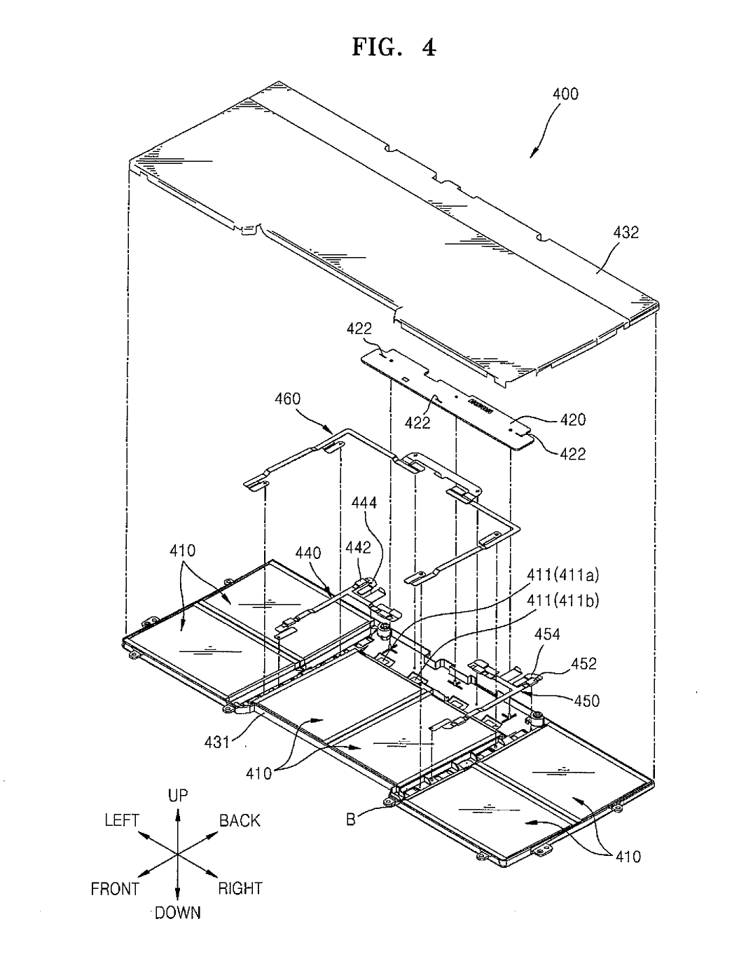

FIG. 4 is an exploded perspective view schematically illustrating a battery pack 400 according to an embodiment of the present invention.

Referring to FIG. 4, the battery pack 400 includes a plurality of battery cells 410, a protection circuit module 420, a lower case 431 and an upper case 432, and a first lead plate 440, a second lead plate 450, and a third lead plate 460 that electrically connect the plurality of battery cells 410 and the protection circuit module 420 to each other.

The battery cells 410, in one embodiment, may be polymer cells. For example, the battery cells 410 may be manufactured by accommodating an electrode assembly in which a positive electrode plate (not shown) and a negative electrode plate (not shown) are alternately stacked by interposing a separator (not shown) between the positive electrode plate and the negative electrode plate, thereby separating the positive electrode plate and the negative electrode plate from each other. The electrode assembly may be wound in the form of a jelly roll, and accommodated in a pouch in which an electrolyte is accommodated. Electrode tabs 411 including a positive electrode tab 411a and a negative electrode tab 411b that are electrically connected to the positive electrode plate and the negative electrode plate, respectively, may be taken out from a side of the battery cell 410.

The protection circuit module 420 may prevent or substantially prevent overheating and explosion from occurring due to overcharge, overdischarge or overcurrent of the plurality of battery cells 410. The protection circuit module 420 may include a safety element including a passive element, such as a resistor or capacitor, or an active element, such as a field effect transistor, or direct circuits.

The protection circuit module 420 may include terminals 422 to be electrically connected to the plurality of battery cells 410. The protection circuit module 420 may include connectors (not shown) to be electrically connected to an external electronic device.

The lower case 431 and the upper case 432 face each other and accommodate the plurality of battery cells 410 and the protection circuit module 420. An accommodation space, in which the plurality of battery cells 410 and the protection circuit module 420 are accommodated, is defined by the lower case 431, and the lower case 431 may include a barrier “B” that prevents or substantially prevents a short circuit between peripheral devices.

The lower case 431 and the upper case 432 may include an electrically insulating material. For example, the lower case 431 and the upper case 432 may be formed of an injection-molded material of insulating resin, such as a plastic. In one embodiment, the lower case 431 and the upper case 432 may be manufactured of an insulating film having rigidity (e.g., predetermined rigidity). In one embodiment, the lower case 431 and the upper caser 432 may include a thin metal material of which an outer surface is coated with an insulating film.

The first through third lead plates 440, 450, and 460 may electrically connect the plurality of battery cells 410 and may concurrently (e.g., simultaneously) connect the battery cells 410 and the protection circuit module 420. For example, the first lead plate 440 may be electrically connected to positive electrodes of battery cells 410 (e.g., three battery cells 410) disposed at the left side of the battery pack 400, and the second lead plate 450 may be electrically connected to negative electrodes of battery cells 410 (e.g., three battery cells 410) disposed at the right side of the battery pack 400, thereby constituting large current terminals of the battery pack 400. The third lead plate 460 may be electrically connected to negative electrodes of battery cells 410 (e.g., three battery cells 410) disposed at the left side of the battery pack 400 and to positive electrodes of battery cells 410 (e.g., three battery cells 410) disposed at the right side of the battery pack 400, thereby connecting battery cells 410 (e.g., six battery cells 410) in series.

In one embodiment, the battery pack 400 illustrated in FIG. 4 includes six battery cells 410. However, the illustrated embodiment is merely one example of the present invention, and the battery pack 400 is not limited to the structure and number of battery cells 410 illustrated in FIG. 4.

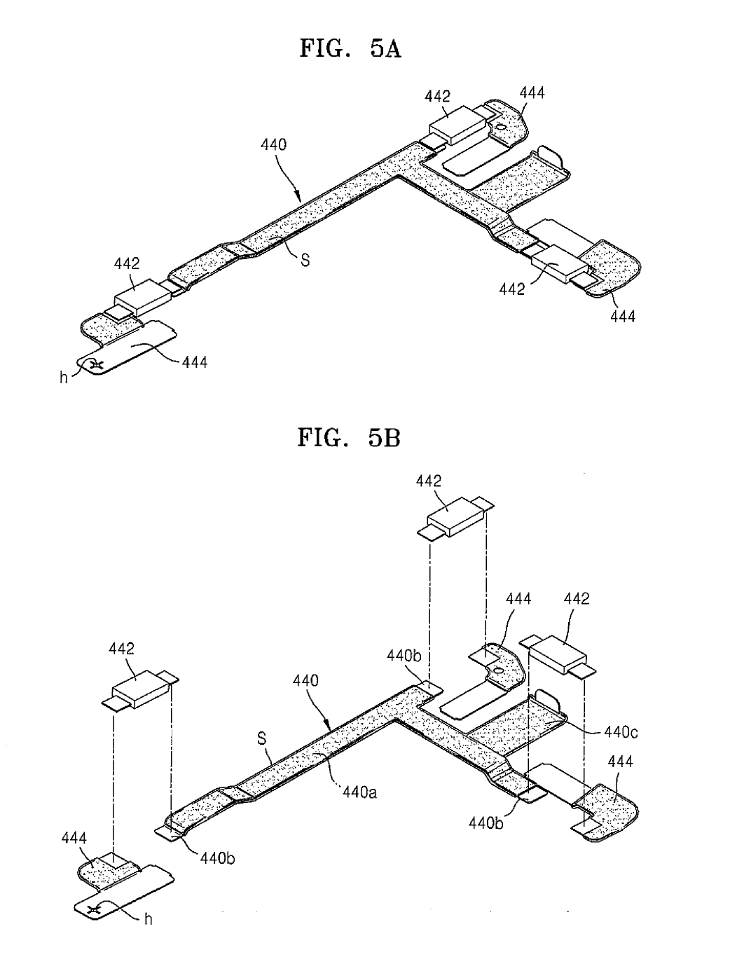

FIG. 5A is a perspective view of the first lead plate 440, a temperature cutoff (TCO), and auxiliary lead tabs of the battery pack 400 illustrated in FIG. 4; and FIG. 5B is an exploded perspective view of the first lead plate 440, the TCO, and the auxiliary lead tabs of FIG. 5A.

Referring to FIGS. 5A and 5B, in one embodiment, the first lead plate 440, or lead electrode, is formed by integrating two metallic layers with each other such that a body portion 440a, electrode connecting portions 440b, and a terminal connecting portion 440c of the first lead plate 440 are formed. In one embodiment, the body portion 440a of the first lead plate 440 may be formed as two metallic layers, and each of the electrode connecting portions 440b and the terminal connecting portion 440c may be formed as one metallic layer. The first lead plate 440, excluding a portion for electrical connection by welding, may be surrounded by an insulating material “S.” A structure of the first lead plate 440 may be the same or similar to that described above with respect to FIGS. 1A through 1C, and, thus, further description thereof will not be provided here.

The first lead plate 440, in one embodiment, includes electrode connecting portions 440b (e.g., three electrode connecting portions 440b) so as to be electrically connected to positive electrodes of battery cells 410 (e.g., three battery cells 410). In one embodiment, when the electrode connecting portions 440b are electrically connected to the positive electrodes of the battery cells 410, auxiliary lead tabs 444 may be further provided to connect them.

In one embodiment, the auxiliary lead tabs 444 may be formed of a single metallic layer of which one side is electrically connected to the electrode connecting portions 440b, and the other side is directly welded to the positive electrode tab 411a that is a positive electrode of the battery cell 410.

In one embodiment, a temperature cutoff (TCO) 442 may be connected between one side of the auxiliary lead tabs 444 and the electrode connecting portions 440b. The TCO 442 may be connected to one side of the auxiliary lead tabs 444 and the electrode connecting portions 440b, such as by welding. The TCO 442 may serve as a fuse that cuts off a current when a temperature of the battery cells 410 exceeds a reference temperature.

In one embodiment, a hole “h” is formed in each of the auxiliary lead tabs 444. When the hole “h” of the auxiliary lead tab 444 is engaged with a protrusion (not shown) formed in the lower case 431, one side of the auxiliary lead tab 444 may be welded to the positive electrode tab 411a of the battery cell 410. For example, the hole “h” may have a circular shape, a “*” shape, a “+” shape, or a combined shape thereof.

In one embodiment, the auxiliary lead tab 444 and the first lead plate 440 are mechanically connected to each other, such as by welding, and, thus, a position of the first lead plate 440 may be fixed. Thus, even when an external vibration is transferred to the battery pack 400, an electrical connection between the first lead plate 440 and the battery cells 410 may be stably maintained.

The first lead plate 440 includes the terminal connecting portion 440c so as to electrically connect the battery cells 410 and the protection circuit module 420. The terminal connecting portion 440c extends from a side of the first lead plate 440, and an end of the terminal connecting portion 440c that is not surrounded by the insulating material “S” may be electrically connected to the protection circuit module 420, such as by welding.

As described above, the first lead plate 440 is electrically connected to the TCO 442 and the auxiliary lead tabs 444. In one embodiment, such a structure may apply to the second lead plate 450 such that the second lead plate 450 is electrically connected to the negative electrode tab 411b that is a negative electrode of the battery cells 410 disposed at a side (e.g., the right side) of the battery pack 400. The second lead plate 450 may have a same or similar structure as that of the first lead plate 440 described above and shown in FIGS. 5A and 5B, and, thus, further description thereof will not be provided here.

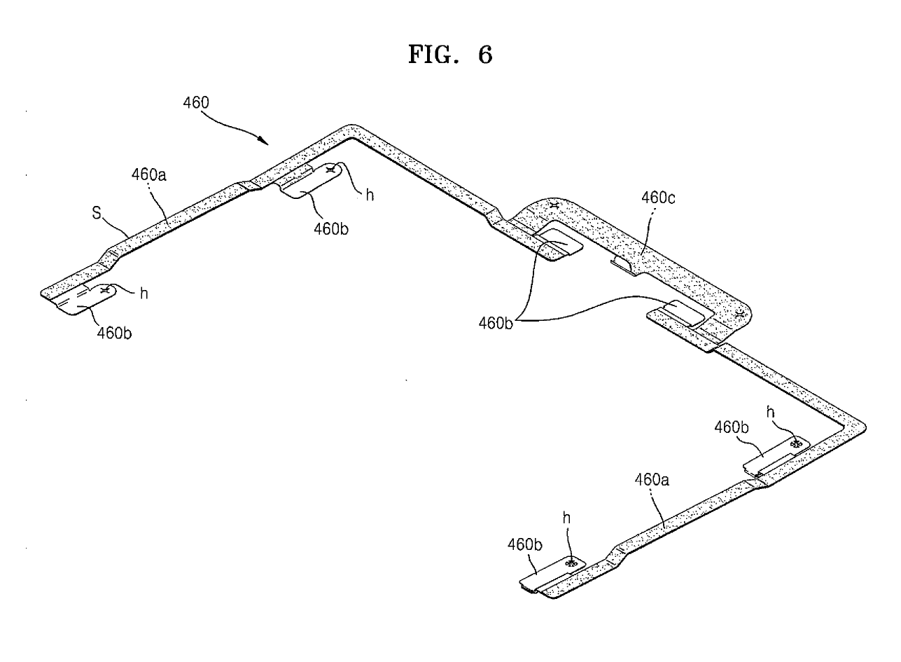

FIG. 6 is a perspective view of the third lead plate 460 of the battery pack 400 illustrated in FIG. 4.

Referring to FIG. 6, in one embodiment, the third lead plate 460, or lead electrode, is formed by integrating two metallic layers with each other such that a body portion 460a, electrode connecting portions 460b, and a terminal connecting portion 460c of the third lead plate 460 are formed. In one embodiment, the body portion 460a of the third lead plate 460 may be formed as two metallic layers, and each of the electrode connecting portions 460b and the terminal connecting portion 460c may be formed as one metallic layer. In one embodiment, the third lead plate 460, excluding a portion for electrical connection, such as by welding, may be surrounded by an insulating material “S.”

Referring to FIGS. 4 and 6, some of the electrode connecting portions 460b of the third lead plate 460 are connected to positive electrodes of the battery cells 410, and the other electrode connecting portions 460b of the third lead plate 460 are electrically connected to negative electrodes of the battery cells 410. For example, electrode connecting portions 460b (e.g., three electrode connecting portions 460b) disposed at the left side of the battery pack 400 may be welded to negative electrodes of battery cells 410 (e.g., three battery cells 410), and electrode connecting portions 460b (e.g., three electrode connecting portions 460b) disposed at the right side of the battery pack 400 may be welded to positive electrodes of the battery cells 410 (e.g., three remaining battery cells 410).

In one embodiment, a hole “h” is formed in at least one of the electrode connecting portions 460b and may be engaged with a protrusion (not shown) formed in the lower case 431. The hole “h” may have a circular shape, a “k” shape, a “+” shape, or a combined shape thereof. By engaging the hole “h” and the protrusion (not shown) with each other, a position of the third lead plate 460 may be fixed. Thus, even when an external vibration is transferred to the battery pack 400, an electrical connection between the third lead plate 460 and the battery cells 410 may be stably maintained.

The terminal connecting portion 460c of the third lead plate 460 extends from the body portion 460a in a direction and, in one embodiment, has a greater width than a width of the body portion 460a. An end of the terminal connecting portion 460c may be electrically connected to the protection circuit module 420, such as by welding.

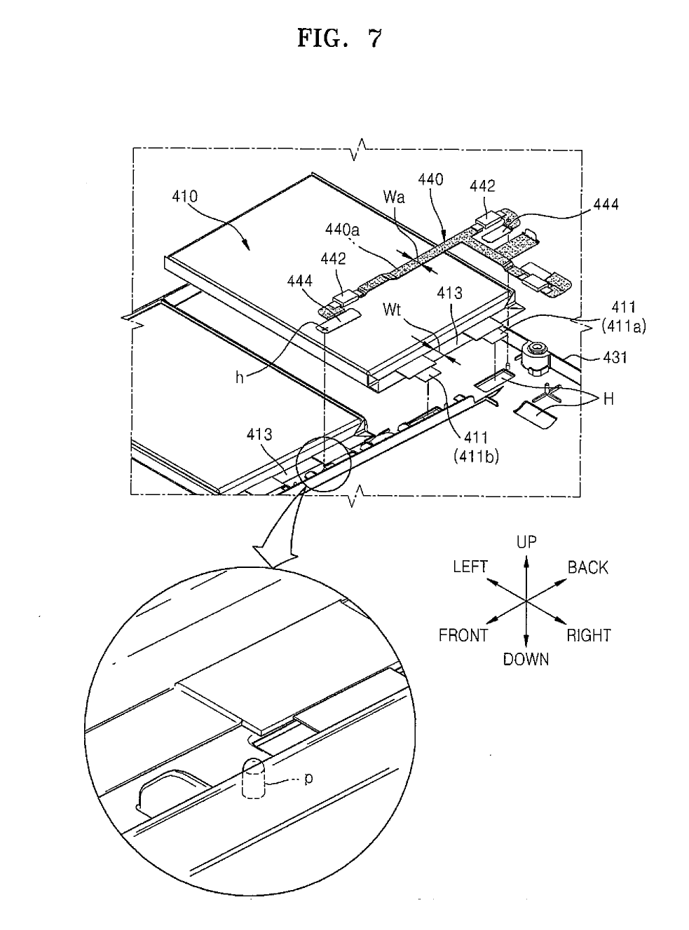

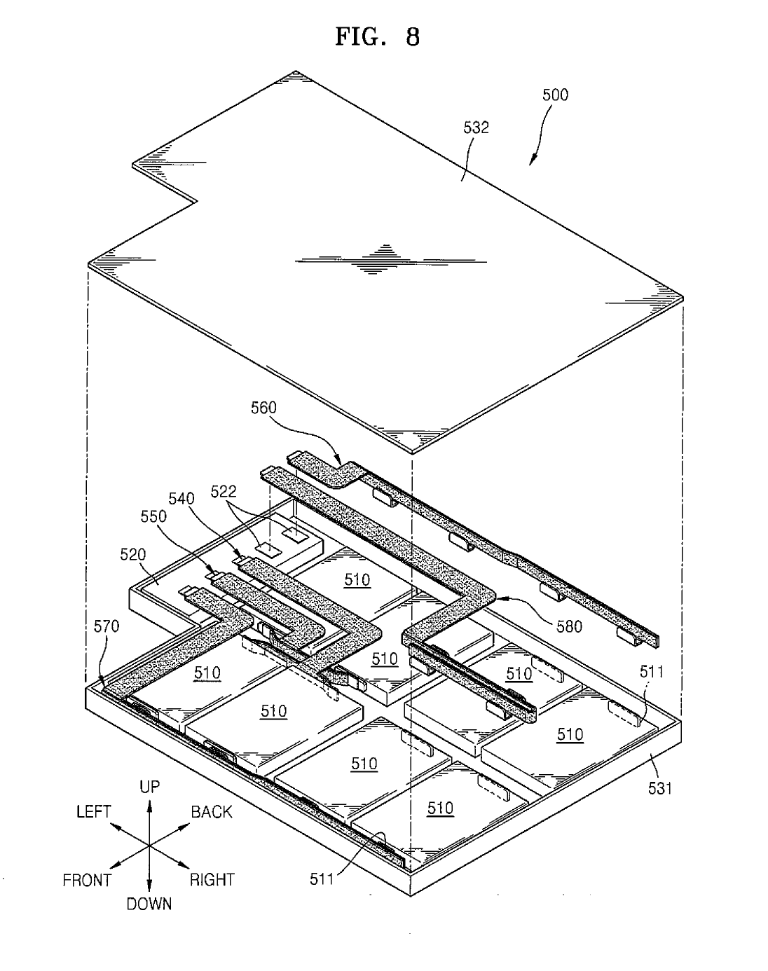

FIG. 7 is a partially exploded perspective view of a portion of the battery pack 400 illustrated in FIG. 4.

Referring to FIG. 7, the plurality of battery cells 410 are accommodated in the lower case 431. According to one embodiment, two of the battery cells 410 that are electrically connected to each other by the first lead plate 440, are accommodated in the lower case 431 such that the electrode tab 411 is directed rightward, and the other one battery cell (not shown) that is electrically connected to the first lead plate 440 may be accommodated in the lower case 431 such that the electrode tab 411 is directed backward. A terrace portion 413 may be disposed at a side of the battery cell 410, such as at a side from which the electrode tab 411 is taken out.

The battery cells 410 may be electrically connected to each other by the first lead plate 440. For example, the auxiliary lead tabs 444 that are electrically connected to the electrode connecting portions 440b of the first lead plate 440 may be welded to the electrode tab 411 of the battery cells 410 such that the plurality of battery cells 410 are electrically connected to each other. In one embodiment, the TCO 442 may be disposed between the auxiliary lead tab 444 and the electrode connecting portion 440b, as described above.

The first lead plate 440 may be disposed above the terrace portion 413 of each of the battery cells 410. In one embodiment, a width of the first lead plate 440, for example, a width Wa of the body portion 440a is the same as or less than a width Wt of the terrace portion 413. In one embodiment, two metallic layers overlap with each other such that the width Wa of the body portion 440a of the first lead plate 440 may be small while preventing or reducing an increase in resistance of the first lead plate 440. Thus, the first lead plate 440 may be disposed in a narrow space of the terrace portion 413.

When the first lead plate 440 is disposed on the terrace portion 413, the auxiliary lead tabs 444 that are connected to the first lead plate 440 may be disposed on the electrode tab 411, and one end of the auxiliary lead tab 444 may be welded to the positive electrode tab 411a.

In one embodiment, a through hole “H” may be formed in the lower case 431 so as to facilitate welding of the auxiliary lead tabs 444 and the electrode tab 411. Upper and lower portions of a region in which the end of the auxiliary lead tab 444 and the positive electrode tab 411a overlap with each other may be welded by using a welding rod (not shown). In this case, the welding rod that is disposed in the lower portion of the region may contact the electrode tab 411 via the through hole “H,” and the welding rod that is disposed in the upper portion of the region may contact the end of the auxiliary lead tab 444.

In one embodiment, a hole “h” may be formed in the auxiliary lead tab 444. For example, the hole “h” may be formed in the auxiliary lead tab 444, and a protrusion “p” may be formed in the lower case 431 that corresponds to the hole “h.” When the hole “h” formed in the auxiliary lead tab 444 is engaged with the protrusion “p,” a position of the auxiliary lead tab 444 may be fixed, and the auxiliary lead tabs 444 and the positive electrode tab 411a may be easily welded to each other. In addition, when the position of the auxiliary lead tabs 444 is fixed, a position of the first lead plate 440 that is connected to the auxiliary lead tabs 444 may also be fixed.

In one embodiment, a region including battery cells 410 (e.g., three battery cells 410) that are electrically connected to one another by the first lead plate 440 has been described. However, the present invention is not limited thereto. For example, the through hole “H” that is formed in the lower case 431, as described above with reference to FIG. 7, may be formed in a position that corresponds to the electrode tab 411 of the battery cell 410 illustrated in FIG. 7.

In one embodiment, the hole “h” may be formed in the auxiliary lead tabs 444 connected to the second lead plate 450 and the electrode connecting portion 460b of the third lead plate 460, and the protrusion “p” corresponding to the hole “h” may be formed in the lower case 431, as described above.

FIG. 8 is an exploded perspective view schematically illustrating a battery pack 500 according to another embodiment of the present invention.

Referring to FIG. 8, the battery pack 500 includes a plurality of battery cells 510, a protection circuit module 520, a lower case 531 and an upper case 532, and a plurality of lead plates 540, 550, 560, 570, and 580 that electrically connect the plurality of battery cells 510 and the protection circuit module 520.

The battery cells 510, in one embodiment, may be polymer cells. For example, the battery cells 510 may be manufactured by accommodating an electrode assembly in which a positive electrode plate (not shown) and a negative electrode plate (not shown) are alternately stacked by interposing a separator (not shown) between the positive electrode plate and the negative electrode plate, thereby separating the positive electrode plate and the negative electrode plate from each other, and the electrode assembly may be wound in the form of a jelly roll, and accommodated in a polygonal can in which an electrolyte is accommodated.

Electrode terminals 511 are formed on sides of the battery cells 510 and have a protrusion shape. The electrode terminals 511 may be electrically connected to the negative electrode plate of the electrode assembly and thus may constitute negative electrodes. In one embodiment, the can that accommodates the electrode assembly may be electrically connected to the positive electrode plate of the electrode assembly and thus may serve as positive electrodes. Although not shown, in order to prevent or substantially prevent a short circuit between peripheral devices, an outer surface of the can except for a side opposite to a side on which the electrode terminal 511 that is a negative electrode is disposed, may be insulated from peripheral devices.

The protection circuit module 520 may prevent or substantially prevent overheating and explosion from occurring due to overcharge, overdischarge or overcurrent of the plurality of battery cells 510. The protection circuit module 520 may include a safety element including a passive element, such as a resistor or capacitor, or an active element, such as a field effect transistor, or direct circuits.

The protection circuit module 520 may include terminals 522 to be electrically connected to the plurality of battery cells 510. The protection circuit module 520 may include connectors (not shown) to be electrically connected to an external electronic device.

The lower case 531 and the upper case 532 face each other and accommodate the plurality of battery cells 510 and the protection circuit module 520. An accommodation space, in which the plurality of battery cells 510 and the protection circuit module 520 are accommodated, is defined by the lower case 531, and the lower case 531 may include barriers (not shown) that prevent or substantially prevent a short circuit between peripheral devices.

The lower case 531 and the upper case 532 may include an electrically insulating material. For example, the lower case 531 and the upper case 532 may be formed of an injection-molded material of insulating resin, such as a plastic. In one embodiment, the lower case 531 and the upper case 532 may be manufactured of an insulating film having rigidity (e.g., predetermined rigidity). In one embodiment, the lower case 531 and the upper caser 532 may include a thin metal material of which an outer surface is coated with an insulating film.

The plurality of lead plates 540, 550, 560, 570, and 580 may electrically connect the plurality of battery cells 510 and may concurrently (e.g., simultaneously) connect the battery cells 510 and the protection circuit module 520. In one embodiment, the battery cells 510 include an embedded fuse (not shown) and do not include the TCO 422 as in the first and second lead plates 440 and 450 of the battery pack 400 illustrated in FIGS. 4 through 7, and the auxiliary lead tabs 444 may not be provided.

The battery pack 500 according to one embodiment in which two parallel-connected battery cells 510 are connected in series is described below. However, the described embodiment is merely one example, and the battery pack 500 illustrated in FIG. 8 is not limited to the above-described structure.

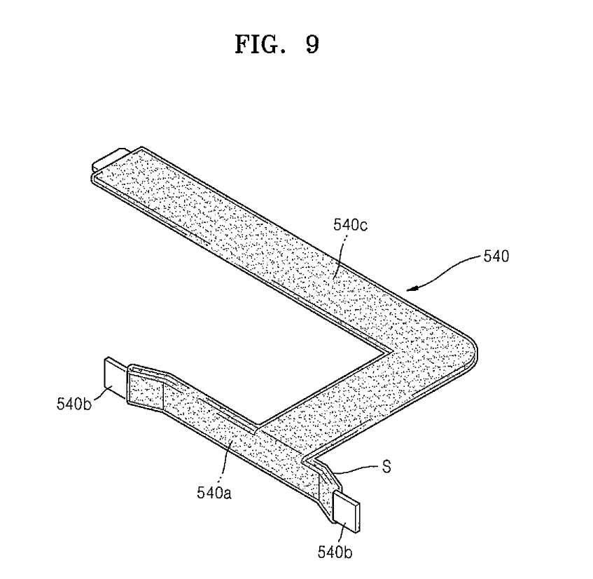

FIG. 9 is a perspective view of a first lead plate 540 of the battery pack 500 illustrated in FIG. 8.

Referring to FIG. 9, in one embodiment, the first lead plate 540, or lead electrode, is formed by integrating two metallic layers with each other such that a body portion 540a, electrode connecting portions 540b, and a terminal connecting portion 540c of the first lead plate 540 are formed. In one embodiment, the body portion 540a of the first lead plate 540 may be formed as two metallic layers, and each of the electrode connecting portions 540b and the terminal connecting portion 540c may be formed as one metallic layer. In one embodiment, the first lead plate 540 excluding a portion for electrical connection by welding may be surrounded by an insulating material “S.” The first lead plate 540 may have a same or similar structure as that of the lead plate 20 described above with respect to FIGS. 2A and 2B, and, thus, further description thereof will not be provided here.

Referring to FIGS. 8 and 9, a width of the body portion 540a of the first lead plate 540 may be the same as or less than a thickness of the battery cell 510. As described above, in one embodiment, two metal layers overlap with each other such that the width of the body portion 540a of the first lead plate 540 may be small while preventing or reducing an increase in resistance of the first lead plate 540. Thus, the body portion 540a of the first lead plate 540 may be disposed along sides of the battery cells 510 having small thicknesses.

The electrode connecting portions 540b of the first lead plate 540 may be welded to electrodes of the battery cells 510, such as to positive electrodes of battery cells 510 (e.g., two battery cells 510) that are disposed at the front left side of the battery pack 500. In one embodiment, each of the electrode connecting portions 540b is formed as one metallic layer, and, thus, the electrode connecting portions 540b may be easily welded.

In one embodiment, the terminal connecting portion 540c of the first lead plate 540 may be welded to the terminals 522 of the protection circuit module 520 and may be bent approximately perpendicular to the body portion 540a so as to be parallel to a top surface of the battery cell 510. If the terminal connecting portion 540c is formed as two metallic layers, the overall thickness of the battery pack 500 is increased by the thickness of the terminal connecting portion 540c that passes through a top surface of the battery cell 510. However, since the terminal connecting portion 540c illustrated in FIG. 9 is formed as one metallic layer, the overall thickness of the battery pack 500 may be reduced or minimized.

The first lead plate 540, in one embodiment, may be welded to positive electrodes of battery cells 510 (e.g., two battery cells 510) that are disposed at the front left side of the battery pack 500, thereby constituting a positive electrode of a large current terminal. The second lead plate 550 is disposed adjacent to the first lead plate 540 and may be welded to positive electrodes of battery cells 510 (e.g., two battery cells 510) that are disposed at the back left side of the battery pack 500, thereby constituting a positive electrode of a large current terminal. The second lead plate 550 may have a same or similar structure as that of the first lead plate 540, and, thus, further detailed description thereof will not be provided here.

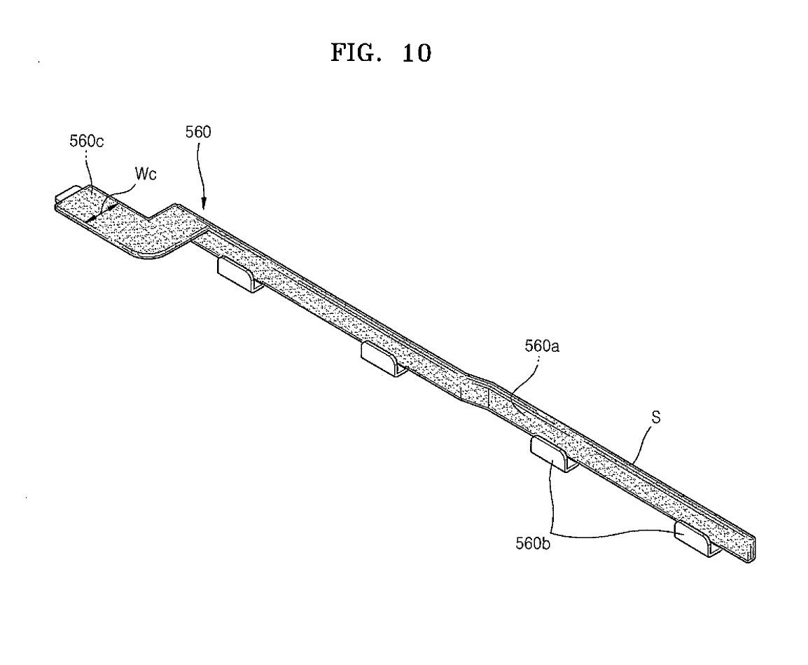

FIG. 10 is a perspective view of a third lead plate 560 of the battery pack 500 illustrated in FIG. 8.

Referring to FIG. 10, in one embodiment, the third lead plate 560, or lead electrode, is formed by integrating two metallic layers with each other such that a body portion 560a, electrode connecting portions 560b, and a terminal connecting portion 560c of the third lead plate 560 are formed. In one embodiment, the body portion 560a of the third lead plate 560 may be formed as two metallic layers, and each of the electrode connecting portions 560b and the terminal connecting portion 560c may be formed as one metallic layer. The third lead plate 560 excluding a portion for electrical connection by welding may be surrounded by an insulating material “S.”

In one embodiment, the electrode connecting portions 560b of the third lead plate 560 are welded to electrodes of the battery cell 510 and may be bent toward the body portion 560a so as to be approximately parallel to the body portion 560a. In one embodiment, a width of the electrode connecting portion 560b may be the same as or less than a width of the body portion 560a such that the bent electrode connecting portions 560b do not protrude in a widthwise direction of the body portion 560a, as described above with reference to FIGS. 3A and 3B.

Referring to FIGS. 8 and 10, the width of the body portion 560a of the third lead plate 560 may be the same as or less than the thickness of the battery cell 510. As described above, in one embodiment, two metal layers overlap with each other such that the width of the body portion 560a of the third lead plate 560 may be small while preventing or substantially preventing an increase in resistance of the third lead plate 560. Thus, the body portion 560a of the third lead plate 560 may be disposed along sides of the battery cells 510 having small thicknesses.

In one embodiment, the terminal connecting portion 560c of the third lead plate 560 may be welded to the terminals 522 of the protection circuit module 520 and may be bent approximately perpendicular to the body portion 560a so as to be parallel to a top surface of the battery cell 510. The terminal connecting portion 560c, in one embodiment, is formed as one metallic layer, and, thus, the overall thickness of the battery pack 500 may be reduced or minimized.

The width of the terminal connecting portion 560c may be greater than that of the body portion 560a so as to prevent or substantially prevent resistance of the third lead plate 560 from being increased when a current that has flowed through the body portion 560a of the third lead plate 560 flows through the terminal connecting portion 560c, as described above.

In one embodiment, the third lead plate 560 electrically connects battery cells 510 (e.g., four battery cells 510) that are disposed in a rear direction of the battery pack 500 to one another, and the fourth lead plate 570 is disposed symmetrically or substantially symmetrically to the third lead plate 560 and electrically connects battery cells 510 (e.g., four battery cells 510) that are disposed in a front direction of the battery pack 500 to one another. The fifth lead plate 580 electrically connects battery cells 510 (e.g., four battery cells 510) that are disposed in a side-to-side direction of the battery pack 500 to one another. The structures of the fourth lead plate 570 and the fifth lead plate 580 may be the same or similar to the structure of the third lead plate 560 and, thus, further detailed description thereof will not be provided here.

In one embodiment, the first and second lead plates 540 and 550 have the structure or a similar structure to that of the lead plate 20 illustrated in FIGS. 2A through 2C. However, the present invention is not limited thereto. For example, the first and second lead plates 540 and 550 may have a structure in which the electrode connecting portions 540b protrude not from both ends, but from sides of the body portion 540a and may be bent, as in the third through fifth lead plates 560, 570, and 580. That is, the first and second lead plates 540 and 550 may have the structure or a similar structure to that of the lead plate 30 illustrated in FIGS. 3A through 3C.

The battery packs 400 and 500 described herein with respect to FIGS. 4 and 8 include a lead plate including a body portion that, in one embodiment, is formed as two metallic layers and has a small width and thus may use a narrow space efficiently. In addition, since, in one embodiment, each of the electrode connecting portions and the terminal connecting portion is formed as one metallic layer, the electrode connecting portions and the terminal connecting portion may be easily welded.

A width of the terminal connecting portion formed as one metallic layer may be large such that an increase in resistance of the terminal connecting portion may be prevented or reduced, and since the thickness of the terminal connecting portion is small, the overall thickness of the battery pack may be reduced or minimized.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. Descriptions of features or aspects within each embodiment should typically be considered as available for other similar features or aspects in other embodiments.

What is claimed is:

1. A battery pack comprising:
a battery cell;
a protection circuit module electrically connected to the battery cell;
a case accommodating the battery cell; and
a lead electrode electrically connected between the protection circuit module and the battery cell, the lead electrode comprising:
a plurality of end connecting portions, each connected to the battery cell or the protection circuit module; and
a body portion connecting the plurality of end connecting portions and having a thickness greater than a thickness of the end connecting portions.

2. The battery pack of claim 1, wherein a width of an end connecting portion of the plurality of end connecting portions is greater than a width of the body portion.

3. The battery pack of claim 2, wherein the end connecting portion of the plurality of end connecting portions is connected to the protection circuit module.

4. The battery pack of claim 1, wherein the body portion comprises first and second overlapping metallic layers.

5. The battery pack of claim 4, wherein an end connecting portion of the plurality of end connecting portions comprises a connecting portion of the first metallic layer that extends beyond and is not overlapped with the second metallic layer.

6. The battery pack of claim 4, wherein the first and second metallic layers are integrated together by at least one of welding or a conductive adhesive.

7. The battery pack of claim 1,
wherein the battery cell comprises an electrode tab at a first side thereof, and
wherein an end connecting portion of the plurality of end connecting portions is connected to the electrode tab.

8. The battery pack of claim 7,
wherein the battery cell further comprises a terrace portion at the first side, and
wherein a width of the body portion is less than or equal to a width of the terrace portion.

9. The battery pack of claim 1, wherein an end connecting portion of the plurality of end connecting portions and the body portion are bent with respect to each other.

10. The battery pack of claim 1, wherein a width of the body portion is less than or equal to a thickness of the battery cell.

11. The battery pack of claim 1,
wherein the lead electrode further comprises an insulating material surrounding the body portion, and
wherein at least a portion of each of the end connecting portions is exposed outside the insulating material.

12. The battery pack of claim 1, further comprising an auxiliary lead tab electrically connected between an end connecting portion of the plurality of end connecting portions and the battery cell.

13. The battery pack of claim 12,
wherein the auxiliary lead tab has a hole formed therein, and
wherein the case comprises a protrusion engaged in the hole to fix a position of the auxiliary lead tab relative to the case.

14. The battery pack of claim 12, further comprising a temperature cutoff (TCO) electrically connected between the end connecting portion of the plurality of end connecting portions and the auxiliary lead tab.

15. The battery pack of claim 1,
wherein an end connecting portion of the plurality of end connecting portions has a hole formed therein, and
wherein the case comprises a protrusion engaged in the hole to fix a position of the end connecting portion of the plurality of end connecting portions relative to the case.

16. A lead electrode for a battery pack, the lead electrode comprising:
a plurality of end connecting portions; and
a body portion connecting the plurality of end connecting portions and having a thickness greater than a thickness of the end connecting portions.

17. The lead electrode of claim 16, wherein a width of an end connecting portion of the plurality of end connecting portions is greater than a width of the body portion.

18. The lead electrode of claim 16, wherein the body portion comprises first and second overlapping metallic layers.

19. The lead electrode of claim 18, wherein the first and second metallic layers are integrated together by at least one of welding or a conductive adhesive.

20. The lead electrode of claim 16, further comprising an insulating material surrounding the body portion, at least a portion of each of the end connecting portions being exposed outside the insulating material.
